(19) United States
(12) Patent Application Publication
(10) Pub. No.: US 2016/0192600 A1
(43) Pub. Date: Jul. 7, 2016

(54) APPARATUS FOR GROWING PLANTS USING HYDROGELS AND ROOT CHANNELS

(71) Applicants: RAHUL BHATT, CUPERTINO, CA (US); AMINE BOUBEZARI, SANTA CLARA, CA (US)

(72) Inventors: RAHUL BHATT, CUPERTINO, CA (US); AMINE BOUBEZARI, SANTA CLARA, CA (US)

(73) Assignees: AMINE BOUBEZARI, SANTA CLARA, CA (US); RAHUL BHATT, CUPERTINO, CA (US)

(21) Appl. No.: 14/588,412

(22) Filed: Jan. 1, 2015

(51) Int. Cl. A01G 9/02

(52) U.S. Cl. CPC A01G 9/02

(57) ABSTRACT

An apparatus (100) for cultivating a plant is disclosed. The apparatus includes a container (102) made of a biodegradable material. The container has a top portion (104), a base portion (106), and a surface portion (108). The apparatus (100) further includes a plant-cultivating medium (110) contained in the container (102). The plant-cultivating medium (110) includes water-retaining hydrogels. The plant-cultivating medium (110) is operable to retain water and to limit release of the water. The apparatus (100) also includes a plurality of tube shaped root channels. A bottom end of a root channel (112a) is close to the base portion (106) and a top end of the root channel is further from the base portion (106). The root channel (112a) is sufficiently wide to allow growth of a root of the plant through the root channel (112a).

### FIELD OF THE INVENTION

The present invention relates generally to cultivation systems, more particularly, to a hydrogel controlled plant cultivation systems.

### BACKGROUND

Global warming and vegetation loss have had a profound, and often negative, effect on environments worldwide. This is especially true in the desert areas, such as the Sahara region, where vegetation loss and increasing temperatures have accelerated the deserts southward expansion. This expansion of desert is known as desertification. Not only does desertification threaten to wipe out an agricultural way of living predominant in the area but also catalyzes a vicious cycle where even more vegetation is destroyed, and the desert's growth is accelerated even more. So dire is the situation that a huge initiative was proposed by 21 African nations, called the Green Wall Project, to construct a 15 mile wide wall of trees to block the Sahara's southward growth. However, this auspicious project with so much potential remains only an initiative mainly because of the pressing concern of how to plant and maintain these trees over a large area in such a harsh environment.

Apart from desert regions many areas in which plants are grown lack optimal growing conditions. Lack of moisture, nutrients, etc. may hinder seed germination and plant growth. Diseases, weeds, insects, animals (e.g., that scavenge seeds shortly after planting), etc. may cause similar effects. Further, many farmers in suboptimal growing areas lack general planting, cultivation, and harvesting knowledge needed to successfully grow crops, and plants. The inability to grow and cultivate plants, especially staple crops (for example, corn, rice, sorghum, soybeans, wheat, etc.), and these, such as fruit bearing trees can have a devastating effect on the health and well being of people living in these areas.

Moreover, gardening is an active hobby in many developed nations. However, traditional gardening, especially in semi-arid regions, is difficult, time consuming, and resource intensive.

Existing approaches of solving the problem of desertification have limitations. For example, Miracle-Gro soil enhancement involves placing additives in soil to make it more conducive to planting. However, it does not provide any means to hydrate the plant; it only provides the soil with nutrients. Therefore, it cannot be used in dry regions where water is scarce.

Bio Bag Max Air II (or composting bucket) provides a composting bucket such as the Bio Bag Max Air II. This allows for a plant to grow within the container and provides it with compost material. However, this requires a lot of maintenance because the planter must replace the compost. Additionally, the bucket does not decompose and therefore requiring massive efforts to remove the large amount of hazardous plastic from the soil.

Groasis Waterboxx was created to aid the growth of plants in harsh climates. This solution relies on rainfall to water the plant, and requires regular maintenance. It includes a bucket, which must be placed in the ground and then removed after a few years. After removal protection must be installed to prevent water evaporation. The Waterboxx also relies on stored rainfall to hydrate the plant. This is not suitable for regions with scarce rainfall, such as the Sahel region in Africa.

Water-retaining hydrogels have been used in the prior arts to enhance the hydration of the roots of live plants, where plants are planted in pots that contain hydrogels. Because the hydrogels retains water well, less water is required for plants that reside in pots containing hydrogel. Similarly, hydrogels may be added to the dirt in a hole in the ground before a plant is put into the hole. However, this solution requires constant maintenance since the moisture escapes relatively quickly. Moreover directly placing hydrogels can only sustain small plants, not trees, due to their limited moisture capacity.

Accordingly, there is a need for a solution that facilitates successful planting of seeds and plants, protects the plant in a dry and harsh environment, promotes and improves cultivation and yield, and improves the quality of nearby soil.

### SUMMARY

In an embodiment, an apparatus for cultivating a plant is provided. The apparatus including a container that is at least partially made of a biodegradable material. The container has a top portion, a base portion, and a surface portion. The apparatus further including a plant-cultivating medium contained in the container. The plant-cultivating medium including water-retaining hydrogels. The plant-cultivating medium is operable to retain water and to limit release of the water. The apparatus also including a plurality of tube shaped root channels such that a bottom end of each root channel is close to the base portion and a top end of each root channel is further from the base portion. Each root channel is sufficiently wide to facilitate growth of at least a portion of root of the plant through the root channel.

In another embodiment, an apparatus for cultivating a plant is disclosed. The apparatus including a container made of starch-based bioplastic. The container having a top portion, a base portion, and a surface portion. The apparatus further including, a plant-cultivating medium contained in the container. The plant-cultivating medium including water-retaining hydrogels, soil, sand, and an additive. The plant-cultivating medium is operable to retain water and to limit release of the water. Typically, the additive is at least one of from the group comprising a fertilizer, a pesticide, a herbicide, a fungicide, a hormone, a steroid, a fungus capable of mycorrhizal association with the plant, and a bacteria capable of making sandy soil conducive to growth of the plant. The apparatus also including, a plurality of tube shaped root channels. A bottom end of each root channel is close to the base portion of the container and a top end of each root channel is further from the base portion. Each root channel is sufficiently wide to facilitate growth of at least a portion of root of the plant through the root channel.

In yet another embodiment, an apparatus for cultivating a plant is disclosed. The apparatus including a container that is at least partially made of a biodegradable material. The container having a top portion, a base portion, and a surface portion. The apparatus further including a plant-cultivating medium contained in the container. The plant-cultivating medium including water-retaining hydrogels, soil, and an additive. The plant-cultivating medium being operable to retain water and to limit release of the water. The additive is at least one of an additive that promotes germination, growth or yield; and an additive that promotes pest resistance. The apparatus further including a plurality of tube shaped root channels. Typically, a bottom end of each root channel is close to the base portion of the container and a top end of each root channel is further from the base portion. Each root channel has a higher concentration of hydrogels compared to the plant-cultivating medium outside the root channels. Further, each root channel is sufficiently wide to facilitate growth of at least a portion of root of the plant through the root channel.

According to an aspect, the plant-cultivating medium including at least one of soil, sand, compost, and an additive.

According to another aspect, the additive is at least one of an additive that promotes germination, growth or yield; and an additive that promotes pest resistance.

In an embodiment, the additive is at least one of a fertilizer, a pesticide, a herbicide, a fungicide, a hormone, a steroid, a fungus capable of mycorrhizal association with the plant, and a bacteria capable of making sandy soil conducive to growth of the plant. Typically, the additive is bacteria Sporosarcina pasteurii.

According to an aspect of the invention, the additive is selected based on at least one of the plant and an environment in which the container containing the plant-cultivating medium is to be disposed. Typically, the hydrogels include at least one of polyvinylalcohols, polyacrylonitrile, and polyacrrylamides.

In an embodiment, the plurality of root channels are filled with the plant-cultivating medium. Typically, the plant-cultivating medium filling the plurality of root channels has a higher concentration or density of hydrogels compared to the plant-cultivating medium outside the plurality of root channels.

In an embodiment, the plurality of root channels are made of biodegradable material. Typically, each root channel of the plurality of root channels extends from a mid portion of the container to the base portion. Each root channel is substantially parallel to a vertical center axis of the container, wherein the vertical axis is a geometrical center axis of the container. In an embodiment, one or more root channels of the plurality of root channels have at least one portion that is extending outward from the vertical center axis of the container.

In an embodiment, shape of the container is at least one of cylindrical, cuboid, cubical, tapered cylinder, and conical. Typically, at least a part of the top portion of the container is open. In an embodiment, a sloped cover is attached to the container such that any precipitation on the sloped cover slides into the container.

In an embodiment, the biodegradable material of the container is starch-based bioplastic.

In an embodiment, the concentration of hydrogels in the plant cultivation medium increases from the top portion of the container to the base portion.

In an embodiment, the base portion 106 of the container has one or more apertures. The one ore more apertures are sufficiently wide to allow at least a portion of the root of the plant to pass through. These apertures allow the roots to grow downward when they outgrow the bucket. In an embodiment, the bottom end of the root channel is aligned with an aperture (i.e. directly above the aperture).

Other aspects, embodiments and advantages of the embodiments described herein will become apparent from the following description and the accompanying drawings, illustrating the principles of the embodiments by way of example only.

### BRIEF DESCRIPTION OF THE FIGURES

The following figures form part of the present specification and are included to further demonstrate certain aspects of the present claimed subject matter, and should not be used to limit or define the present claimed subject matter. The present claimed subject matter may be better understood by reference to one or more of these drawings in combination with the description of embodiments presented herein. Consequently, a more complete understanding of the present embodiments and further features and advantages thereof may be acquired by referring to the following description taken in conjunction with the accompanying drawings, in which like reference numerals may identify like elements, wherein:

FIG. 1 shows an apparatus 100 for cultivating a plant in accordance with an embodiment of the present invention;

FIG. 2 is a cross section view 200 of the apparatus 100 in accordance with an embodiment of the invention;

FIG. 3 is a top view 300 of the apparatus 100 in accordance with an embodiment of the invention;

FIGS. 4A, 4B, 4C, 4D, 4E, 4F and 4G illustrate shapes of the container 102 in accordance with various embodiments of the present invention;

FIGS. 5A, 5B, 5C, 5D, 5E and 5F illustrate shapes of the root channel 112 in accordance with various embodiments of the present invention;

FIG. 6 is a cross section view of the apparatus 100 illustrating a sloped cover 602 in accordance with an embodiment of the invention;

FIG. 7 is a cross section view 700 of the apparatus 100 depicting growth of a plant in accordance with an embodiment of the invention; and

FIG. 8 illustrates a plantation grid 800 depicting a plan for planting trees and/or plants in accordance with various embodiments of the present invention.

Skilled artisans will appreciate that elements in the figures are illustrated for simplicity and clarity and have not necessarily been drawn to scale. For example, the dimensions of some of the elements in the figures may be exaggerated, relative to other elements, to help in improving an understanding of the embodiments of the present invention.

### NOTATIONS AND NOMENCLATURE

Certain terms are used throughout the following description and claims to refer to particular apparatus, system components and configurations. As one skilled in the art will appreciate, the same component may be referred to by different names. This document does not intend to distinguish between components that differ in name but not function. In the following discussion and in the claims, the terms “including” and “comprising” are used in an open-ended fashion, and thus should be interpreted to mean “including, but not limited to . . . ” The word “or” is used in the inclusive sense (i.e., “and/or”) unless a specific use to the contrary is explicitly stated. Also, it is to be understood that such terms as “forward,” “rearward,” “left,” “right,” “top,” “bottom,” “upwardly,” “downwardly,” and the like are words of convenience and are not to be construed as limiting terms.

### DETAILED DESCRIPTION

The foregoing description of the figures is provided for the convenience of the reader. It should be understood, however, that the embodiments are not limited to the precise arrangements and configurations shown in the figures. Also, the figures are not necessarily drawn to scale, and certain features may be shown exaggerated in scale or in generalized or schematic form, in the interest of clarity and conciseness. Relatedly, certain features may be omitted in certain figures, and this may not be explicitly noted in all cases.

While various embodiments are described herein, it should be appreciated that the present invention encompasses many inventive concepts that may be embodied in a wide variety of contexts. The following detailed description of exemplary embodiments, read in conjunction with the accompanying drawings, is merely illustrative and is not to be taken as limiting the scope of the invention, as it would be impossible or impractical to include all of the possible embodiments and contexts of the invention in this disclosure. Upon reading this disclosure, many alternative embodiments of the present invention will be apparent to persons of ordinary skill in the art. The scope of the invention is defined by the appended claims and equivalents thereof.

Illustrative embodiments of the invention are described below. In the interest of clarity, not all features of an actual implementation are described or illustrated in this specification. In the development of any such actual embodiment, numerous implementation-specific decisions may need to be made to achieve the design-specific goals, which may vary from one implementation to another. It will be appreciated that such a development effort, while possibly complex and time-consuming, would nevertheless be a routine undertaking for persons of ordinary skill in the art having the benefit of this disclosure.

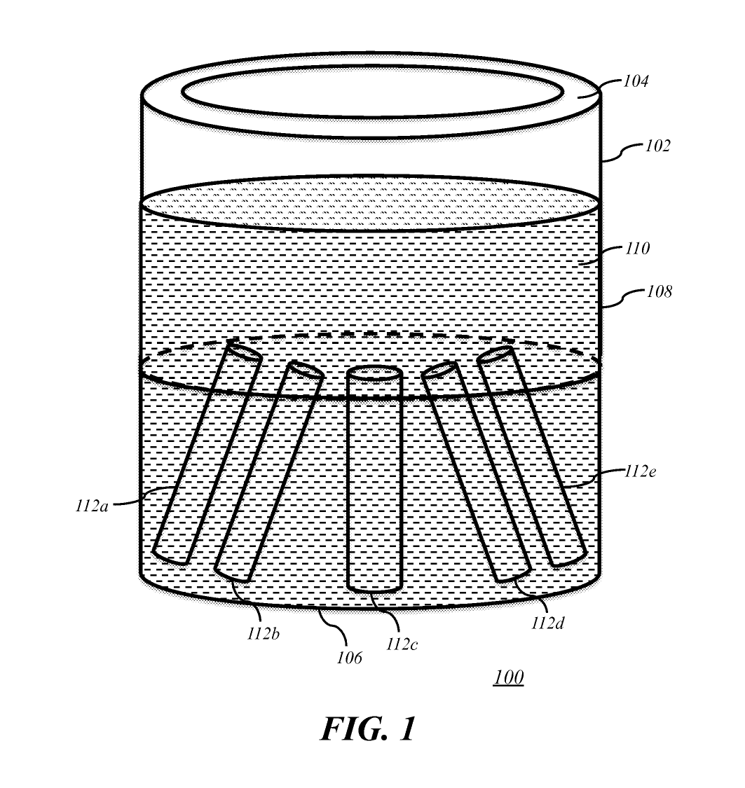

FIG. 1 shows an apparatus 100 for cultivating a plant in accordance with an embodiment of the present invention. The apparatus 100 comprises a container 102 having a top portion 104, a base portion 106, and a surface portion 106. In an embodiment, the top portion 104, the bottom portion 106 and the surface portion 108 are separate. In another embodiment, the top portion 104, the bottom portion 106 and the surface portion 108 are integrally formed. The apparatus 102 further comprises a plant-cultivating medium 110 contained in the container 102. Typically, the plant-cultivating medium 110 comprising water-retaining hydrogels thereby making the plant-cultivating medium 110 capable to retain water and to limit release of the water. Hydrogel are super-absorbent polymers that can hold up to 100 times their weight in water. Hydrogels have been proven in small-scale desert experiments to sustain vegetation for extended periods of time. In an embodiment, the plant-cultivating medium includes 5% to 15% of hydrogels by weight. However, depending on the requirement the proportion of hydrogels can me more or less. The container 102 insulates the hydrogels included in the plant-cultivating medium from the arid or semi-arid soil outside the container. This extends the lifespan of hydrogels and enables them to retain water for a longer period of time and nourish the plant for such longer period of time.

The apparatus 100 also comprises a plurality of tube shaped root channels, for example the root channel 112a, 112b, 112c, 112d, and 112e. Typically, a bottom end of each root channel is close to the base portion 106 and a top end of each root channel is further from the base portion 106. Each root channel is sufficiently wide to facilitate growth of at least a portion of root of the plant through the root channel. Typically, the root channel are hollow cylindrical shaped (tube shaped) and have a diameter of approximately five to eight centimeters to provide ample space for the roots to grow inside them.

In an embodiment, the shape of the container 102 is at least one of cylindrical, cuboid, cubical, tapered cylinder, and conical. Typically, the container 102 is at least partially made of a biodegradable material. In an embodiment, the biodegradable material is starch-based bioplastic. The starch-based bioplastic is a preferred material because it degrades in approximately two years. However, this starch-based bioplastic can very well be substituted with other biodegradable materials. For example, the bioplastic can be PLA (polyactide) based bioplastic, CO2 polymer based bioplastic, or polycaprolactone based bioplastic.

In an embodiment, at least a part of the top portion 104 of the container 102 is open. Typically, the base portion 106 has one or more apertures. Typically, the one ore more apertures are sufficiently wide to allow at least a portion of the root of the plant to pass through.

In an embodiment, the apparatus 100 has a sloped cover attached to the container 102 such that any precipitation on the sloped cover slides into the container 102.

Typically, the soil-cultivating medium 110 comprises at least one of from the group comprising soil, sand, and an additive. The soil used by the inventors for experimentation was “Hydro Clear Bioretention Soil” from the Kurtz Bros. Inc. This soil retains water very well and is designed to foster the growth of plants in a multitude of environments. The Hydro Clear Bioretention Soil also maintains its structure, thus allowing it to retain moisture, which will be vital for the plant growth in arid, semi-arid and desert regions.

In an embodiment, a large component of the soil is sand. Typically, 45% of the soil is made up of sand and minerals, while 25% of it is made up of air, 25% of water, and 5% of organic material. The high amounts of air and water maintain the porosity and permeability of the soil, while retaining structural integrity. The porosity and permeability are necessary in order to disperse water through the soil and into the roots of the plant. The organic matter provides nutrients to the plant. It must be apparent to a person having ordinary skill in the art that depending on the requirement of the plant and/or the environment a different composition of the soil can be used.

Typically, the additive is at least one of from the group comprising an additive that promotes germination, growth or yield; and an additive that promotes pest resistance. Typically, the additive is selected based on at least one of the plant and an environment in which the container containing the plant-cultivating medium is to be disposed.

Typically, the additive is at least one of from the group comprising a fertilizer, a pesticide, a herbicide, a fungicide, a hormone, a steroid, a fungus capable of mycorrhizal association with the plant, and a bacteria capable of making sandy soil conducive to growth of the plant. In an embodiment, the additive comprises bacteria Sporosarcina pasteurii. Sporosarcina pasteurii is capable of making sandy soil conducive to growth of the plant. Swedish architect, Magnus Larsson has already used this bacteria in small scale experiments in the Sahara and has proved that the bacteria does solidify soil and render it more suitable for plants. In the lab, these bacteria were able to solidify 32 square feet of soil in a matter of hours, though it is estimated that it would take around two weeks for in a desert or a semi-arid environment. The invention utilizes the unique property of the bacteria by not just restricting it to the plant or tree in the container 102. Since the bacteria can reproduce indefinitely they can continue to improve surrounding soil after the container 102 has decomposed and continue a process of progressive soil stabilization of the surrounding area. Additionally, the bacteria Sporosarcina pasteurii also helps in degradation of the container 102.

In an embodiment, the hydrogels comprise at least one of polyvinylalcohols, polyacrylonitrile, and polyacrrylamides. In another embodiment, the hydrogels comprises monomers that are at least one of acrylic acid, acrylamide, methacrylamide, 2-acrylamido-2-methyl-propanesulfonic acid, methacrylic acid, vinyl sulfonic acid, ethyl acrylate, potassium acrylate, and derivatives and mixtures thereof. Typically, the concentration of hydrogels in the plant cultivation medium 110 increases from the top portion 104 to the base portion 106. Since the density of hydrogels is highest near the base portion 106 the moisture content will be highest near the base portion. Since roots have a tendency to grow towards moisture/water the roots of the plant will naturally grow towards the base portion and in effect closer toward the groundwater. Accordingly, the invention provides a stepping-stone toward self-sustenance of the young plant/tree by actively encouraging its roots to grow towards and to seek groundwater through deeper roots. It must be apparent to a person skilled in the art that the apparatus 100 can be used for growing a variety of trees and plants without deviating from the scope of the invention.

In an embodiment, the plurality of root channels are made of biodegradable material. Typically, the material of the root channels is same as the material of the container 102. Typically, the biodegradable material is starch-based bioplastic. Bioplastics are plastics derived from renewable biomass sources, such as vegetable fats and oils, corn starch, pea starch, or microbiota. Bioplastic can be made from agricultural byproducts and also from used plastic bottles and other containers using microorganisms.

In an embodiment, the plurality of root channels are filled with the plant-cultivating medium. Typically, the plant-cultivating medium filling the plurality of root channels has a higher concentration of hydrogels compared to the plant-cultivating medium outside the plurality of root channels. For example, the root channels may have 25% by weight of hydrogels compared to 15% by weight in the plant-cultivation medium outside of the root channels. In an embodiment, the root channels are almost entirely filled with hydrogels. In another embodiment, the root channels have a high proportion of hydrogels and the areas surrounding the root channels does not include hydrogels (or a very low concentration of hydrogels). In an embodiment, the root channels may have different concentration of hydrogels from each other as well. Since roots grow towards moisture and water source, this embodiment promotes the growth of the roots of the plant/tree into the plurality of root channels.

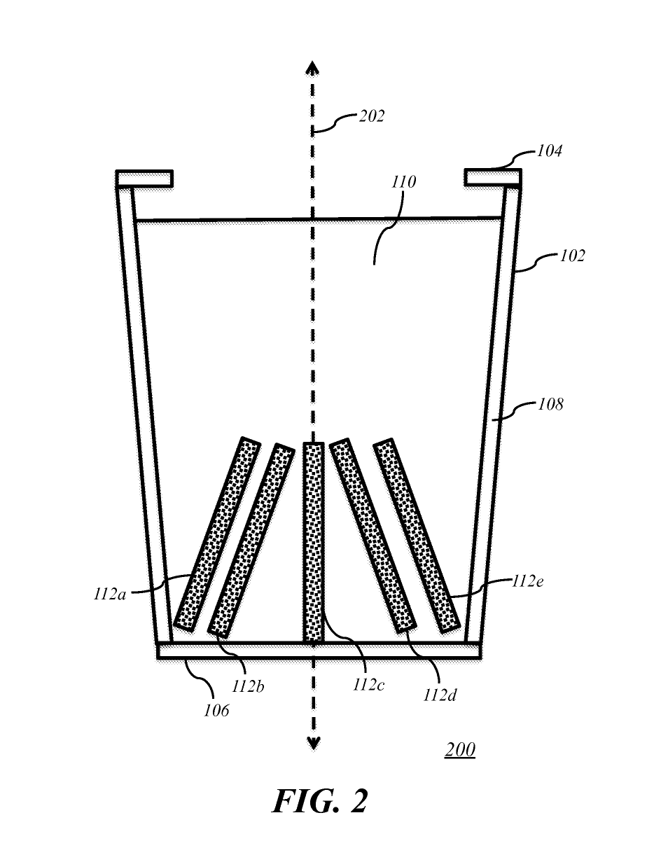

In an embodiment, each root channel of the plurality of root channels, for example root channel 112a extends from a mid portion of the container to the base portion 106. In another embodiment, each root channel of the plurality of root channels, for example root channel 112b extends from is present only in the bottom 25% of the container 102. In yet another embodiment, the root channels within the apparatus 100 may have varying length, width, shape and orientation (vertical, inclined inward, inclined outward etc.). Typically, each root channel is substantially parallel to a vertical center axis of the container 102, wherein the vertical axis is a geometrical center axis of the container. This will explained in conjunction with FIG. 2. In another embodiment, one or more root channels of the plurality of root channels have at least one portion that is protruding/extending outward from the vertical center axis of the container.

Typically, to use the apparatus 100, a user would dig a hole in the ground slightly larger than the size of the container 102. Thereafter the user would place the apparatus 100 into the hole and plant the plant sapling or the tree sapling into the container 102. Thereafter the user should water the plant enough such that the hydrogels in the plant-cultivating medium 110 absorb a significant amount of water. In an embodiment, the apparatus 100 is sufficiently watered in advance and the user may just have to plant the sapling after placing the apparatus 100 into the hole.

In an embodiment, components of the apparatus 100, such as the container 102, the plurality of root channels, and the plant-cultivating medium 110 and the manufactured separately and assembled at the spot for plantation. In another embodiment, the container 110 including the plurality of root channels is manufactured and assembled in advance and the plant-cultivation medium is added at the spot, prior to plantation. Typically, the plant cultivation-medium 110 is prepared by mixing soil, bacteria Sporosarcina pasteurii, and hydrogels in a required proportion. In yet another embodiment, the apparatus 100 including the container 102, the plurality of root channels, the plant-cultivating medium 110, and the plant is assembled in advance so that it can be planted without any assembling required on spot. Typically, the apparatus 100 is able to support a variety of plants including small trees, such as 2-8 inch caliper trees. Moreover, a person having ordinary skill in the art would vary the size of the container and 102 and/or the composition of the plant-cultivation medium 110 accommodate a variety of plant and a tree plantation. Similarly, the size of the container 102 and/or the composition of the plant-cultivation medium 110 can also be altered such that it best suits the environment without deviating from the scope of the invention.

Once the apparatus 100 including the plant is planted into the ground the hydrogels will release water slowly that will provide the required moisture to sustain and grow the plant. The bacteria Sporosarcina pasteurii present in the plant-cultivation medium will solidify the surrounding sandy soil. Typically, the plurality of root channels are located towards the bottom of the container 110. Since the container 102 is closed on the side (the surface portion 108) the roots of the plant will only be able to grow downward into the root channels. In an embodiment, higher concentration of hydrogels inside the root channels and thereby higher moisture and water in the root channels will attract the roots of the plant into the root channels. Once the roots are in the root channel they will be forced to grow vertically downward and into the root channels. When the roots grow downward they would head towards the groundwater. Typically, in arid and semi-arid regions there is moisture in the ground roughly four to five metres below the ground. Once the roots reach a depth of four to five metres, the plant will be able to sustain itself from the moisture in the ground. Moreover, the container 102 would degrade in roughly one to two years (depending on the environment). This would enable the plant to acclimatize with the environment. Since the container 102 is biodegradable, the environmental impact of the apparatus 100 will be minimal.

The use of apparatus 100 including hydrogels and the plurality of root channels ensure that very limited maintenance is required to grow trees. The necessary labor is the initial planting. The carefully designed root channels promote deep root growth and facilitate the planted tree to get access to deep groundwater and/or moisture available in deserts and other rain deficient regions.

FIG. 2 is a cross section view of the apparatus 100 in accordance with an embodiment of the invention. The cross section view depicts the cross section view of the container 102, the top portion 104, the base portion 106, the surface portion 108, the soil-cultivating medium 110, the plurality of root channels 112a, 112b, 112c, 112d, and 112e. The cross section view also depicts a vertical center axis 202 of the container 102.

In an embodiment, the top portion 104 of the container 102 is uncovered. Typically, the bottom quarter of the container 102 comprises the plurality of root channels. In this embodiment, above the root channels i.e. roughly the top three-fourth of the container 102 is where the plant-cultivating medium 110 including soil, sand, hydrogels, bacteria, and the additive is filled. In an embodiment, the bottom portion, for example bottom half or bottom 25% of the container 102 comprises entirely of the plurality of root channels.

Typically, the vertical central axis 202 is the geometrical center axis of the container 102. In an embodiment, one or more root channels are substantially parallel to the vertical center axis 202 of the container 102. In another embodiment, one or more root channels are inclined outward, typically 20 degree to 45 degree, from the vertical central axis 202. In yet another embodiment, one or more root channels of the plurality of root channels have at least one portion that is protruding/extending outward from the vertical center axis 202. In an embodiment, the container 102 is not geometrically symmetric. In this embodiment, the vertical central axis 202 is approximately the geometrical axis of the container 102.

In an embodiment, the container may have a vertical height of one meter. In this embodiment, the root channels may start from 0.5 meter from the top portion 104 and extend till the base portion 106. Typically, the root channels are inclined at an angle of approximately 20 degree with respect to the vertical central axis 202 (as shown in FIG. 2). This angle prevents the clustering of the roots and thus enables them to draw water, mineral resources, and nutrients from a wider area.

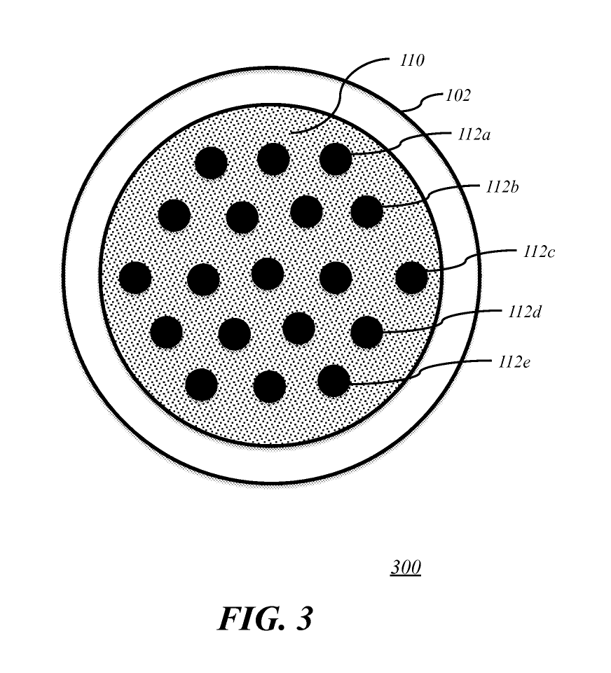

FIG. 3 is a top view 300 of the apparatus 100 in accordance with an embodiment of the invention. The top section view depicts the top portion 104, the soil-cultivating medium 110, and the plurality of root channels, for example the root channels 112a, 112b, 112c, 112d, and 112e.

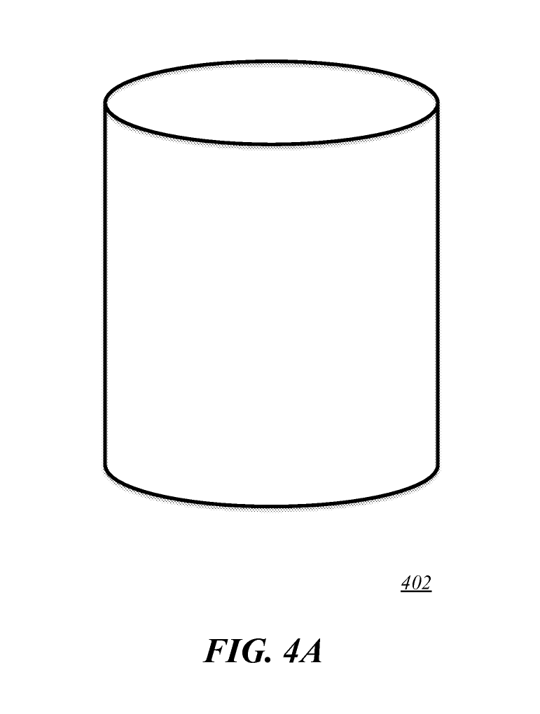

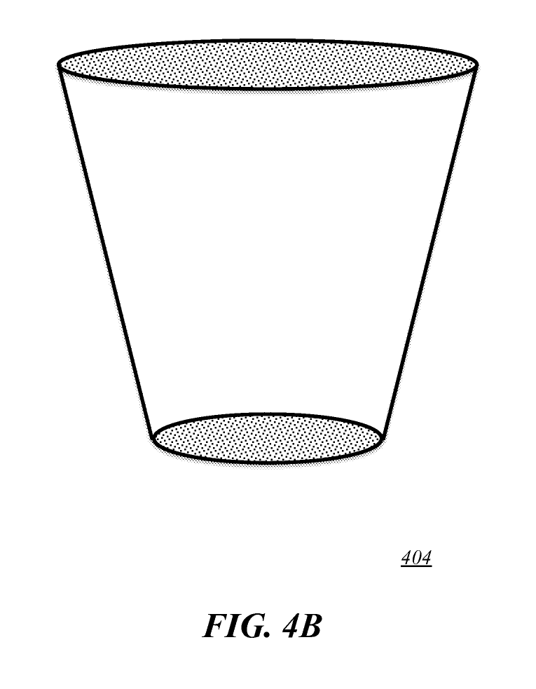

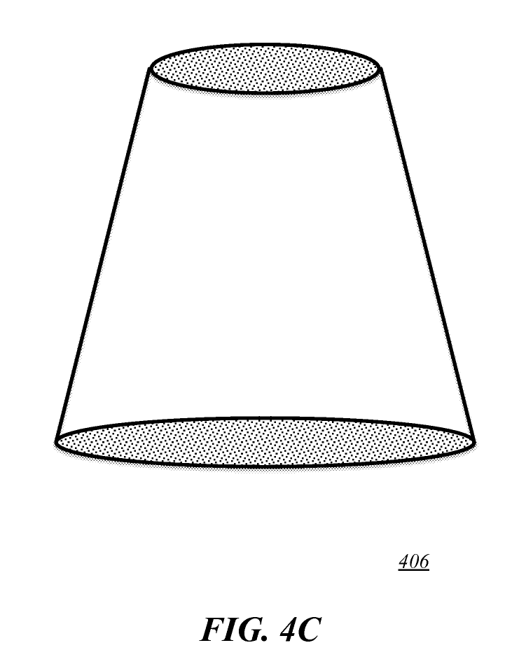

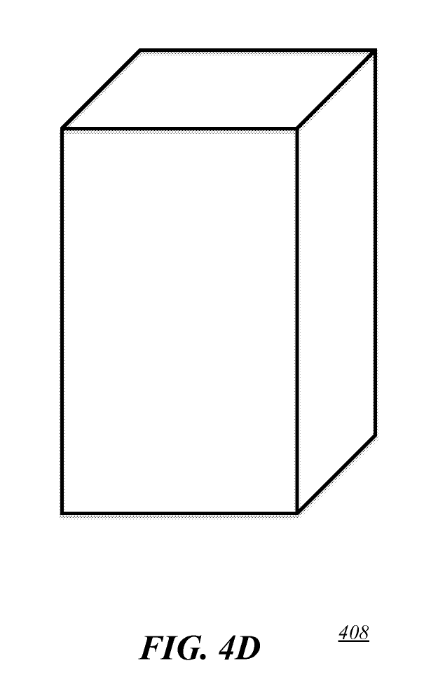

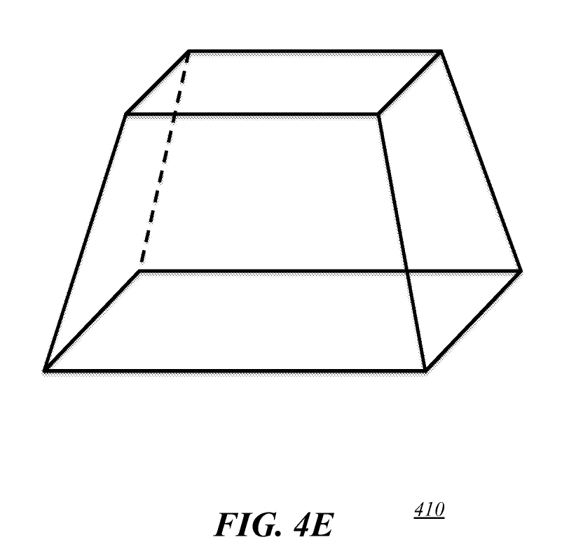

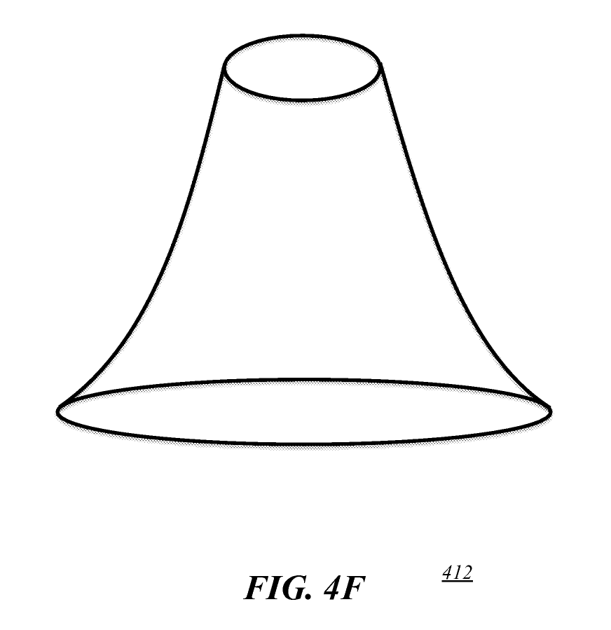

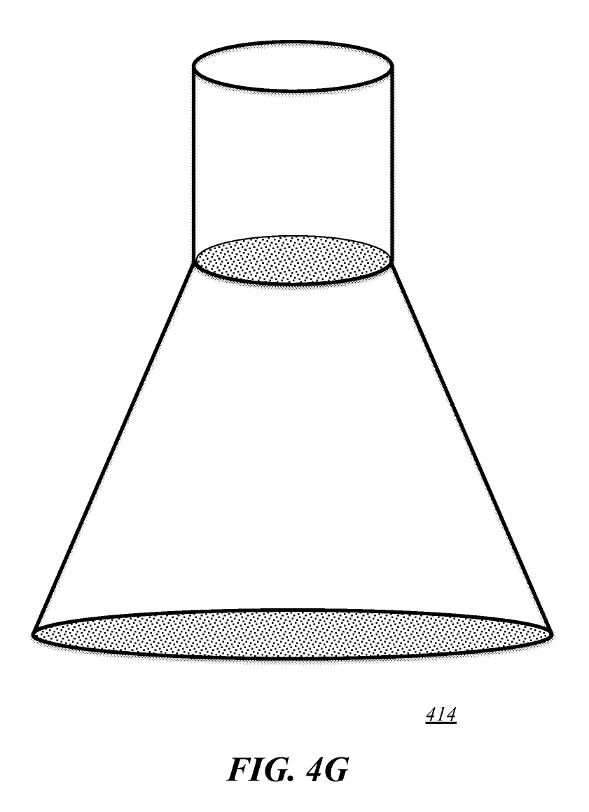

FIGS. 4A, 4B, 4C, 4D, 4E, 4F and 4G illustrate shapes of the container 102 in accordance with various embodiments of the present invention. FIG. 4A illustrate a cylindrical shape 402, FIG. 4B illustrate a tapered cylindrical shape 404, FIG. 4C illustrate a reverse tapered cylindrical shape 406, FIG. 4D illustrate a cuboid shape 408, FIG. 4E illustrate a tapered cuboid shape 410, FIG. 4F depicts a curved conical shape 412. In addition, in an embodiment, the shape of the container 102 may be a combination of 2 or more shapes. For example, FIG. 4G illustrates a cylindrical/conical shape 414. It must clear to a person skilled in the art the illustrated shapes FIG. 4A-G are only illustrative and that the container can have any shape both regular geometrical and irregular.

It must be apparent to the person skilled in the art that a particular shape of the container 102 will depend on at least one of the plant to be grown in the apparatus 100 and an environment in which the container 102 is to be disposed. For example, cylindrical/conical shape 412 may work better in semi-arid environment as the cylindrical/conical shape 412 stores majority of the plant-cultivating medium comprising hydrogels much below the grown and thereby slows down the evaporation of water from the hydrogels.

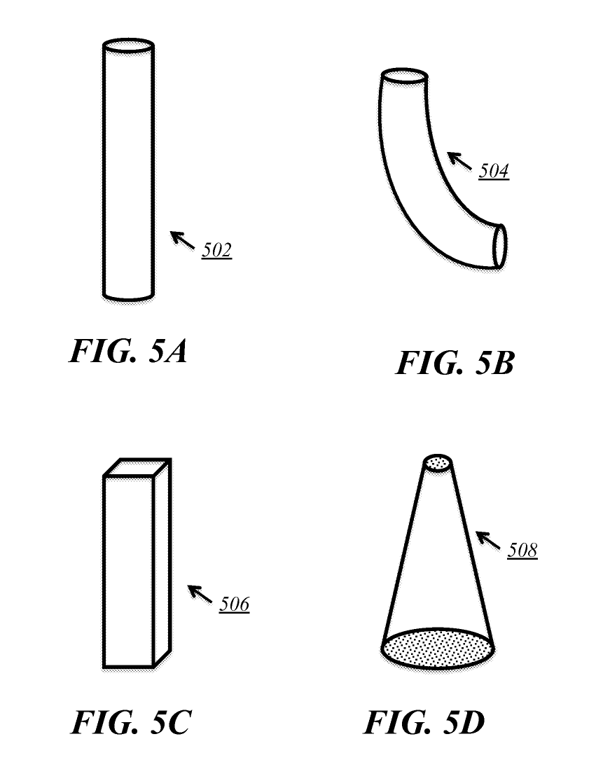

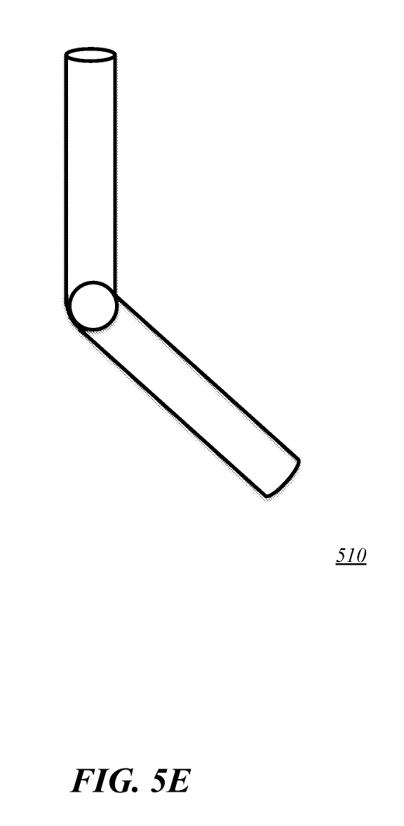

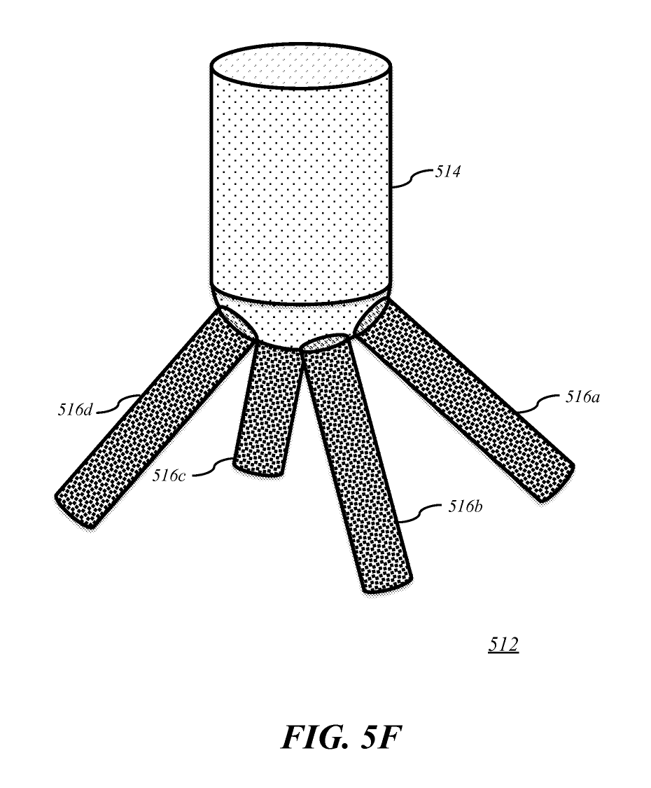

FIGS. 5A, 5B, 5C, 5D, 5E, and 5F illustrate shapes of the root channel 112 in accordance with various embodiments of the present invention. FIG. 5A illustrate a cylindrical shape 502. Typically, shape of a root channel is a hollow cylinder (or tube shape) since this will be suitable for the cylindrical shape of the root of the plant/tree.

FIG. 5B illustrate a curved cylindrical shape 504. FIG. 5C illustrate a cuboid shape 506. FIG. 5D illustrate a tapered cylindrical shape 508. FIG. 5E illustrate a curved shape 510 wherein at least one portion of the root channel protruding outward from the vertical center axis of the container 102. FIG. 5F illustrate a branch shape 512. The branch shape 512 has a base portion 514 and a plurality of branches, for example a branch 516a, a branch 516b, a branch 516c, a branch 516d. Each of the branch 516a-d are shown to be protruding outward in direction from the base portion 514. In an embodiment, the branch shape 512 enables the root of the plant to grow vertically downward into the ground through the base portion 514 and once the root reaches the bottom of the base portion 514, the it may branch out through one ore more of the branches 516a-d. The branching out of the root ensures that each branch of the root is physically separate and do not compete for moisture within a same once they outgrow the root channels.

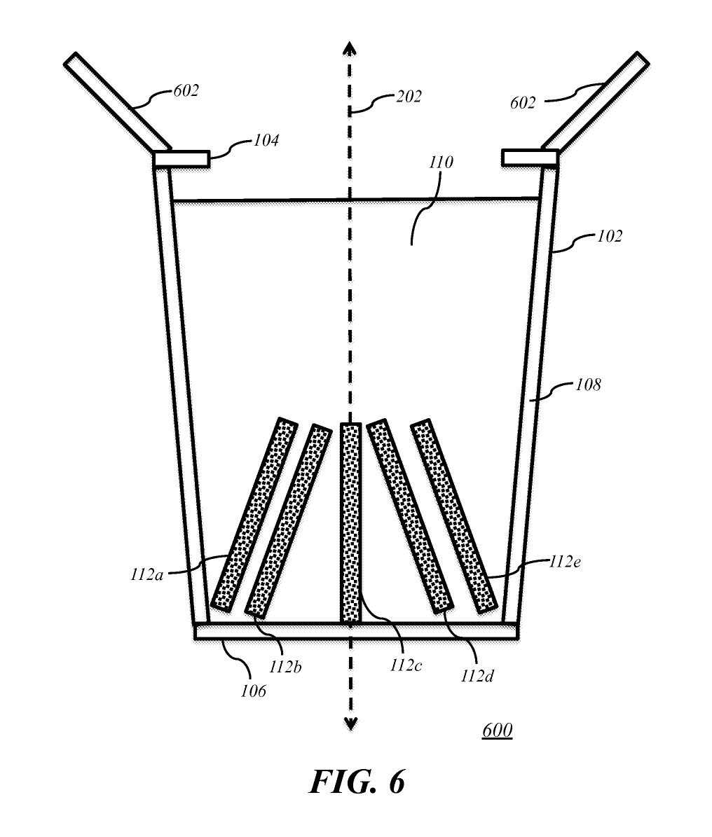

FIG. 6 is a cross section view 600 of the apparatus 100 illustrating a sloped cover 602 in accordance with an embodiment of the invention. Typically, the sloped cover 602 is attached to the container 102 such that any precipitation on the sloped cover slides into the container 102. In an embodiment, the sloped cover 602 is integrally formed with the container 102. In another embodiment, the sloped cover 602 is separate from the container 102. Typically, the sloped cover is made of plastic, carbon fiber, or metal. In an embodiment, the sloped cover is made of biodegradable material such as bio-plastic. Typically, the sloped cover 602 is detachable from the container 102.

In an embodiment, the container 102 has a shape of a tapered cylinder where the tapering angle is between ten and twenty degrees. Typically, the diameter of the top portion is 0.5 meters and the height of the container is 0.75 meters. The plurality of root channels will typically occupy the bottom 0.25 meters of the container. In this embodiment, the majority of the hydrogels may be located in the root channels and in the area surrounding the root channels.

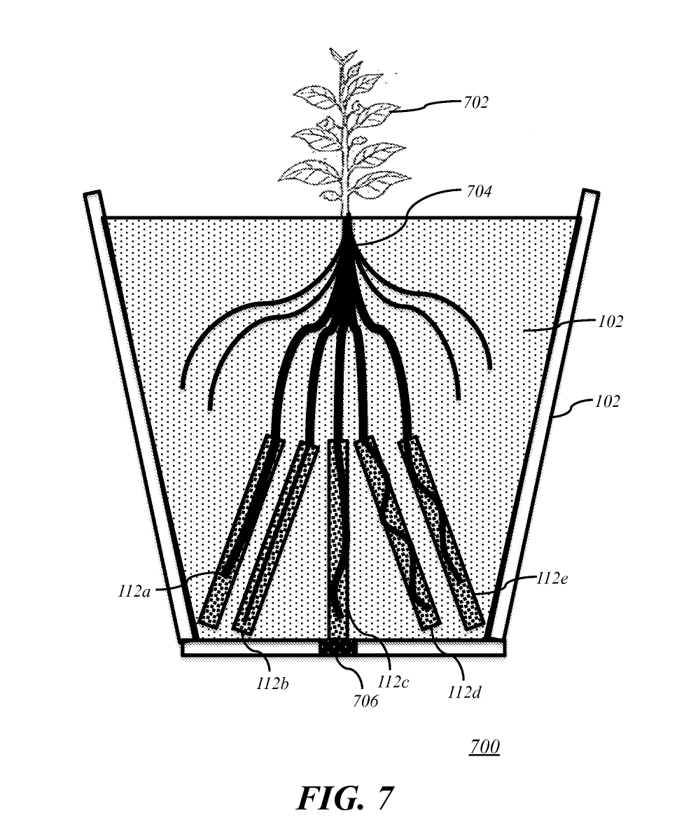

FIG. 7 is a cross section view 700 of the apparatus 100 depicting growth of the plant in accordance with an embodiment of the invention. The cross section view 700 illustrates a plant 702. The plant 702 has root portion 704. The root of the plant 702 is shown to be growing into the plurality of root channels. Accordingly, invention promotes the growth of the roots downwards towards the groundwater and prevents them from spreading horizontally. In an embodiment, once the root 702 reaches the bottom of the root channel, for example root channel 112d it continues to grow downward through an aperture, for example through an aperture 706. Although FIG. 7 illustrates just one plant (the plant 702), more than one plant may simultaneously be grown in the apparatus 100.

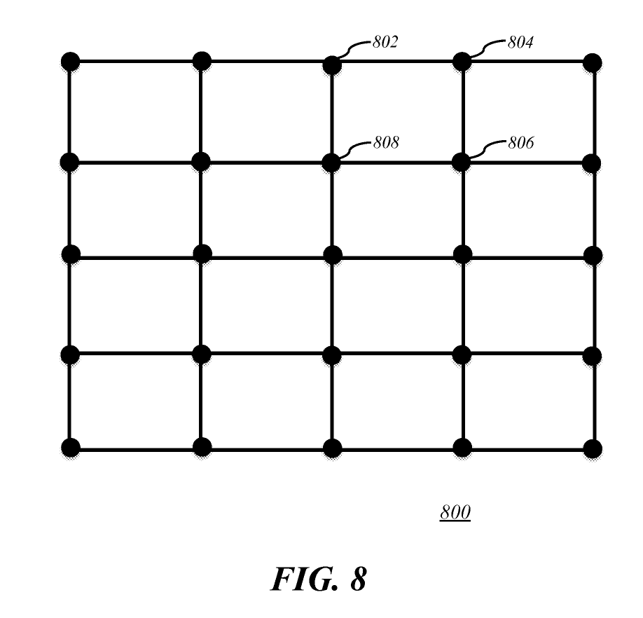

FIG. 8 illustrates a plantation grid 800 depicting a plan for planting trees and/or plants in accordance with various embodiments of the present invention. Typically, the plan of the plantation grid 800 can be implemented is a semi-arid or arid region. The grid 800 including a plurality of nodes, for example node 802, node 804, node 806, and node 808. Each node of the plurality of nodes represents a location in where a plant/tree contained in the apparatus 100 can be planted. Typically the nodes are 10 to 15 meter apart from each other on the ground. The plantation grid 800 can be implemented to prevent the spread of desert and to make the region conducive for plant growth. The bacterial contained in each apparatus 100 will continue to spread and thereby will make the surrounding area more conducive for plant growth. In an embodiment, the plantation grid 800 can be used to implement the Green Wall project in the Sahel region in Africa to prevent the spread of desert. The Green Wall project is an ambitious plantation project proposed by 21 African countries to prevent the spread of the Sahara desert. It involves plantation of a 15 miles wide boundary of trees to block the southward growth of the Sahara.

In the preceding discussion, reference may at times have been made to what are understood to be reasons underlying certain mechanisms, modes of operation or performance, improvements, advantages, etc. of embodiments disclosed herein. While statements of such reasons (whether or not explicitly referred to as “reasons”) represent the inventor's beliefs based on his scientific understanding and experimentation, the inventor nonetheless does not wish to be bound by theory.

In light of the principles and exemplary embodiments described and illustrated herein, it will be recognized that the exemplary embodiments can be modified in arrangement and detail without departing from such principles. Also, the foregoing discussion has focused on particular embodiments, but other configurations are contemplated. In particular, even though expressions such as “in one embodiment,” “in another embodiment,” “in a version of the embodiment” or the like are used herein, these phrases are meant to generally reference the range of possibilities of embodiments, and are not intended to limit the disclosure to the particular embodiments and configurations described herein. As used herein, these terms may reference the same or different embodiments that are combinable into other embodiments.

Similarly, although exemplary processes have been described with regard to particular operations performed in a particular sequence, numerous modifications could be applied to those processes to derive numerous alternative embodiments of the present disclosure. For example, alternative embodiments may include processes that use fewer than all of the disclosed operations, processes that use additional operations, and processes in which the individual operations disclosed herein are combined, subdivided, rearranged, or otherwise altered.

In view of the wide variety of useful permutations that may be readily derived from the exemplary embodiments described herein, this detailed description is intended to be illustrative only, and should not be taken as limiting the scope of the disclosure. What is claimed as the disclosure, therefore, are all implementations that come within the scope of the following claims, and all equivalents to such implementations. In the claims, means-plus-function and step-plus-function clauses, if any, are intended to cover the structures or acts described herein as performing the recited function and not only structural equivalents, but also equivalent structures. Thus, while a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. An apparatus for cultivating a plant, the apparatus comprising:
a) a container at least partially made of a biodegradable material, the container having a top portion, a base portion, and a surface portion;
b) a plant-cultivating medium contained in the container, the plant-cultivating medium comprising water-retaining hydrogels, wherein the plant-cultivating medium is operable to retain water and to limit release of the water; and
c) a plurality of tube shaped root channels, wherein a bottom end of each root channel is close to the base portion and a top end of each root channel is further from the base portion, and wherein each root channel is sufficiently wide to facilitate growth of at least a portion of root of the plant through the root channel.

2. The apparatus according to claim 1 wherein the plant-cultivating medium further comprises at least one of from the group comprising soil, compost, and an additive.

3. The apparatus according to claim 2 wherein the additive is at least one of from the group comprising an additive that promotes germination, growth or yield; and an additive that promotes pest resistance.

4. The apparatus according to claim 2 wherein the additive comprises bacteria Sporosarcina pasteurii.

5. The apparatus according to claim 2 wherein the additive is at least one of from the group comprising a fertilizer, a pesticide, a herbicide, a fungicide, a hormone, a steroid, a fungus capable of mycorrhizal association with the plant, and a bacteria capable of making sandy soil conducive to growth of the plant.

6. The apparatus according to claim 2 wherein the additive is selected based on at least one of the plant and an environment in which the container containing the plant-cultivating medium is to be disposed.

7. The apparatus according to claim 1 wherein the hydrogels comprise at least one of polyvinylalcohols, polyacrylonitrile, and polyacrrylamides.

8. The apparatus according to claim 1 wherein the plurality of root channels are filled with the plant-cultivating medium.

9. The apparatus according to claim 8 wherein the plant-cultivating medium filling the plurality of root channels has a higher proportion of hydrogels compared to the plant-cultivating medium outside the plurality of root channels.

10. The apparatus according to claim 1 wherein the plurality of root channels are made of biodegradable material.

11. The apparatus according to claim 1 wherein each root channel of the plurality of root channels extend from a mid portion of the container to the base portion, and wherein each root channel is substantially parallel to a vertical center axis of the container, wherein the vertical center axis is a geometrical center axis of the container.

12. The apparatus according to claim 11 wherein one or more root channels of the plurality of root channels have at least one portion that extends outward from the vertical center axis of the container.

13. The apparatus according to claim 1 wherein shape of the container is at least one of from the group comprising cylindrical, cuboid, cubical, tapered cylinder, and conical.

14. The apparatus according to claim 1 wherein at least a part of the top portion of the container is open.

15. The apparatus according to claim 1 wherein the biodegradable material is starch based bioplastic.

16. The apparatus according to claim 1 wherein concentration of hydrogels in the plant cultivation medium increases from the top portion to the base portion.

17. The apparatus according to claim 1 further comprising a sloped cover attached to the container such that any precipitation on the sloped cover slides into the container.

18. The apparatus according to claim 1 wherein the base portion has one or more apertures, wherein the one ore more apertures are sufficiently wide to allow at least a portion of the root of the plant to pass through.

19. An apparatus for growing a plant, the apparatus comprising:
a) a container made of starch based bioplastic, the container having a top portion, a base portion, and a surface portion;
b) a plant-cultivating medium contained in the container, the plant-cultivating medium comprising water-retaining hydrogels, soil, sand, and an additive; and wherein the plant-cultivating medium is operable to retain water and to limit release of the water, and wherein the additive is at least one of from the group comprising a fertilizer, a pesticide, a herbicide, a fungicide, a hormone, a steroid, a fungus capable of mycorrhizal association with the plant, and a bacteria capable of making sandy soil conducive to growth of the plant.
c) a plurality of tube shaped root channels, wherein a bottom end of each root channel is close to the base portion and a top end of each root channel is further from the base portion, and wherein each root channel is sufficiently wide to facilitate growth of at least a portion of root of the plant through the root channel.

20. An apparatus for cultivating a plant, the apparatus comprising:
a) a container at least partially made of a biodegradable material, the container having a top portion, a base portion, and a surface portion;
b) a plant-cultivating medium contained in the container, the plant-cultivating medium comprising water-retaining hydrogels, soil, and an additive; and wherein the plant-cultivating medium is operable to retain water and to limit release of the water, and wherein the additive is at least one of from the group comprising an additive that promotes germination, growth or yield; and an additive that promotes pest resistance; and
c) a plurality of tube shaped root channels, wherein a bottom end of each root channel is close to the base portion and a top end of each root channel is further from the base portion, wherein each root channel has a higher concentration of hydrogels compared to the plant-cultivating medium outside the root channels, and wherein each root channel is sufficiently wide to facilitate growth of at least a portion of root of the plant through the root channel.
